(19) United States
(12) Patent Application Publication
(10) Pub. No.: US 2016/0125209 A1
(43) Pub. Date: May 5, 2016

(54) SYSTEM AND DEVICE FOR SAVING AND SHARING FILES

(71) Applicant: Mark Meyers, Thousand Oaks, CA (US)

(72) Inventor: Mark Meyers, Thousand Oaks, CA (US)

(21) Appl. No.: 14/679,752

(22) Filed: Apr. 6, 2015

Related U.S. Application Data
(60) Provisional application No. 62/074,281, filed on Nov. 3, 2014.

(51) Int. Cl. G06K 7/10; H04W 4/00; H04B 5/00

(52) U.S. Cl. CPC G06K 7/10297; H04B 5/0031; H04W 4/008

(57) ABSTRACT

A scannable tag is provided having an inlay with an NFC chip and an antenna, and a memory element. When a user scans the tag using a scanning device, such as a mobile device, the user is granted access to content on a server associated with the tag. The user may then download onto the mobile device, stream or otherwise access the content from the server.

### CROSS REFERENCE TO RELATED APPLICATIONS

The application claims the benefit of U.S. Provisional Application No. 62/074,281, filed on Nov. 3, 2014, which is incorporated by reference herein in its entirety.

### FIELD OF INVENTION

The invention is related to a system and device for saving files onto a server, and a system and device for sharing files.

### BACKGROUND OF THE INVENTION

The invention relates generally to a system and device for saving files onto a server, and accessing and sharing files saved on a server.

Typically, if a person wants to share a file with another person, the recipient makes a data connection with the device on which the file is stored, or the sharer provides a copy of the file on an external drive, such as a USB (Universal Serial Bus) flash drive. The recipient typically must connect the external drive to his computer, mobile device, etc. in order to access the file being shared. This may be cumbersome, since the sharer may not want to have the recipient connect to his device, whereupon the recipient may have access to all the files saved on the device, potentially spread a virus, etc. Alternatively, the recipient's device may not have the appropriate port or driver to connect to the external drive, and may require the use of cords or other connection means.

Alternatively, a person may upload the file onto a server by logging in from a computer, mobile device, etc. In order to share the file, he would typically send a link to the file location to the recipient. However, many file-sharing services require the recipient to have an account as well.

Accordingly, it is desirable to provide an improved system and device for uploading files onto a server and/or sharing files that overcomes drawbacks and inadequacies of known methods and systems.

### SUMMARY OF THE INVENTIONS

Generally speaking, in accordance with an embodiment of the invention, a tag is capable of wireless data communication with a mobile device, preferably via NFC (Near Field Communication) technology. The tag may include an inlay having an antenna and an NFC integrated circuit chip capable of performing wireless data communication with an NFC-enabled mobile device, such as a cellular phone. The tag preferably also includes a memory element for storing tag data and content data corresponding to content stored on a server, which is accessible wirelessly by the mobile device upon scanning the tag. The mobile device may be able to write onto the tag via an antenna that may be removed or otherwise disabled to prevent further writability.

An embodiment of the invention provides a system comprising a scannable tag, such that upon a user scanning the tag using a scanning device, such as an NFC-enabled mobile device, the user is granted access to content saved on a server. A first user may upload content onto the server and associate the content with the tag, and upon a second user scanning the tag, the second user may select one or more of the content and download them onto the mobile device, stream the content on the mobile device, or whichever capability the first user had granted.

Another embodiment of the invention is directed to a networking system by which persons scanning a common tag may communicate with each other, for example, in a chatroom or other networking system.

Yet another embodiment of the invention is directed to a system in which scanning certain tags earns the scanning user points, coupons, information, etc. as determined by the initial user of the tag.

Still other objects and advantages of the invention will in part be obvious and will in part be apparent from the specification. Other features and advantages of this invention will become apparent in the following detailed description of exemplary embodiments of this invention with reference to the accompanying drawings.

### BRIEF DESCRIPTION OF THE DRAWINGS

For a fuller understanding of the invention, reference is made to the following description taken in connection with the accompanying drawing, in which:

FIG. 1 is a tag according to an exemplary embodiment of the invention;

FIG. 2A is a tag according to an exemplary embodiment of the invention;

FIG. 2B is a tag according to an exemplary embodiment of the invention;

FIG. 3A is a tag according to an exemplary embodiment of the invention;

FIG. 3B is a tag according to an exemplary embodiment of the invention;

FIG. 4A is a tag according to an exemplary embodiment of the invention;

FIG. 4B is a tag according to an exemplary embodiment of the invention;

FIG. 4C is a tag according to an exemplary embodiment of the invention;

FIG. 5A is a tag in a keychain according to an exemplary embodiment of the invention;

FIG. 5B is a plurality of tags and write antennas as charms according to an exemplary embodiment of the invention;

FIG. 6A is a tag in an article of clothing according to an exemplary embodiment of the invention;

FIG. 6B is a tag in a cap according to an exemplary embodiment of the invention;

FIG. 7 is a tag according to an exemplary embodiment of the invention;

FIG. 8 is a tag according to an exemplary embodiment of the invention;

FIG. 9 is a plurality of tags adhered to a surface according to an exemplary embodiment of the invention;

FIG. 10A is a tag having LEDs according to an exemplary embodiment of the invention;

FIG. 10B is a tag having LEDs according to an exemplary embodiment of the invention;

FIG. 10C is a tag having LEDs according to an exemplary embodiment of the invention;

FIG. 11 is a diagram of a system according to an exemplary embodiment of the invention;

FIG. 12 is a block diagram of a system according to an exemplary embodiment of the invention;

FIG. 13 is a tag according to an exemplary embodiment of the invention; and

FIG. 14 is a tag according to an exemplary embodiment of the invention.

### DETAILED DESCRIPTION OF THE PREFERRED EMBODIMENTS

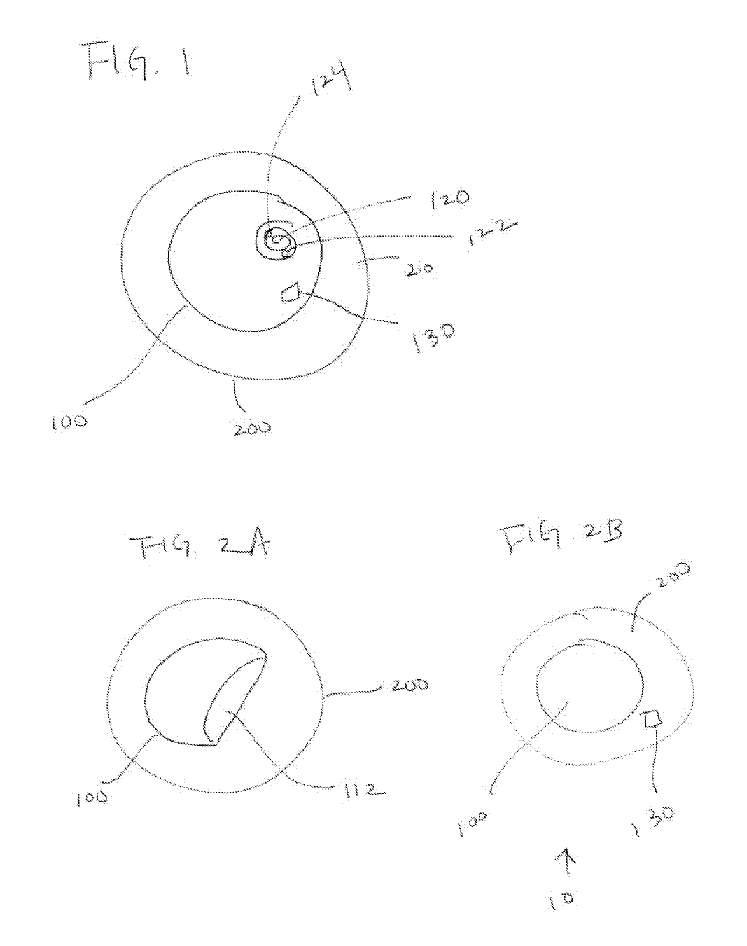

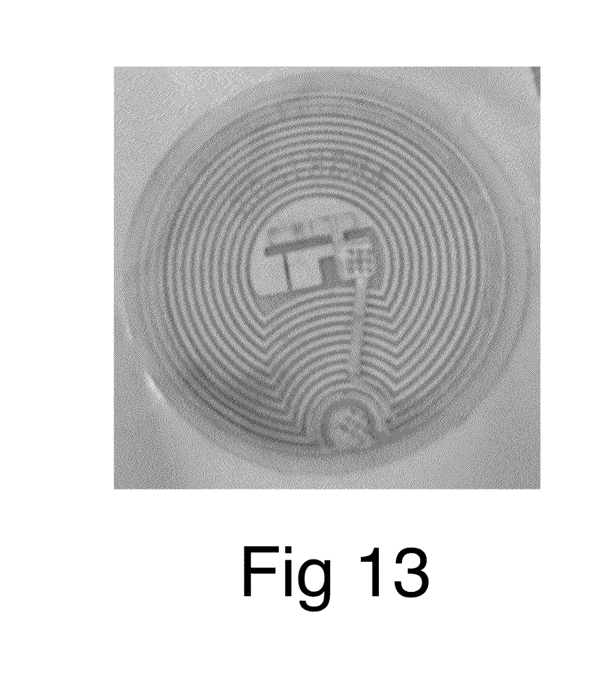

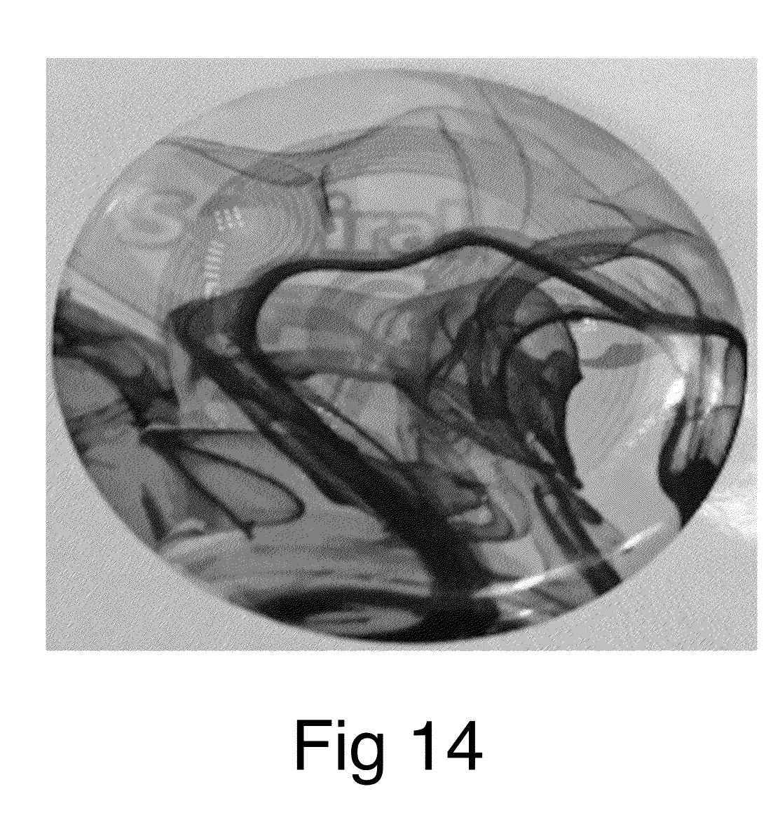

Certain exemplary embodiments of the present invention will now be described with reference to the drawings. Reference is made to FIGS. 1-14, in which certain embodiments of the invention are shown. The invention generally is directed to a device and system for saving files onto a server and/or sharing files. A user preferably has an account associated with a folder on a server, which includes one or more sub-folders, such as “Tag Folders,” into which the user may add content associated with a Tag (described in further detail below). Such content may include digital files, such as image files, video files, documents, etc. (“File Content”); pointers to content on websites or other servers such as Facebook®, YouTube®, mobile or web-based games, mobile apps, music, movies, etc. (“Pointer Content”); or information, such as the user's name, birthday, phone number, email address, details to a party, etc. (“Information Content”); collectively referred to herein as “Tag Content”. The user preferably has a physical device, referred to herein as a “Tag,” which may be scanned or otherwise have its information accessed. When a device capable of scanning or otherwise communicating with the Tag (“Device”), such as an NFC-enabled device, scans the Tag, the Device is granted access to all or some of the Tag Content predetermined by the user. In other words, the Tag may function as a key to open its associated Tag Folder when the Tag is scanned.

Reference is made to FIGS. 1-3B, wherein certain embodiments of Tag 100 are illustrated. Tag 100 preferably has a diameter of between 0.25 inch and 1.5 inches, more preferably about 1 inch, and includes an NFC (Near Field Communication) element, for example, an integrated circuit 120. Integrated circuit 120 has a memory element 122, for example, an erasable programmable read only memory (EPROM) onto which information such as the Tag's unique identification (ID), user ID, Tag's activity history, and other information may be stored.

Memory element 122 may have a plurality of sections, each storing different data. Preferably, memory element 122 has at least three sections: a first section that contains data regarding Tag 100 itself, such as the Tag's 100 unique Tag ID; a second section that contains information regarding the Tag's Tag Content on a server, such as a pointer to the Tag Content (“Tag Pointer”), the name of the folder in which the Tag Content is saved, or other data to identify the Tag Content; and a third section that contains information saved as a log, for example, the Tag's activity history. The activity history may include information regarding what Device communicated with Tag 100; when and where such communications occurred; the details of the communication, such as which content was accessed, whether content was added, downloaded, or removed, etc.

One or more memory sections may be capable of being written to or locked, so that it cannot be written to. The memory sections may be locked during production, by the user, or automatically after use by the user, for example, after a certain period of time has passed since its initial use or the final use, upon reaching the maximum storage capacity, or other conditions.

In accordance with a preferred embodiment, the first section of memory element 122 is written to and locked during production, more preferably by software. The second section is written to by the user and locked either physically or by software. The memory sections may be locked permanently once they are locked, or alternatively, capable of being locked and unlocked. The data saved in the second and/or third section may be shared with an external device or program, such as a mobile device. Preferably, memory element 122 can hold between 1 byte and 2 MB, more preferably between 200 bytes and 2 MB of data.

In the embodiment shown in FIG. 1, Tag 100 further includes an antenna 124. Preferably, integrated circuit 120 is located inside an inlay having antenna 124, which grants access to data stored in memory element 122 of integrated circuit 120 of Tag 100. For example, if a Device, preferably an NFC-enabled mobile phone, scans Tag 100, memory element 122 is accessed via antenna 124. Antenna 124 preferably has a range of 0-3 inches. More preferably, the range is such that the Device need not physically come in contact with Tag 100 to scan it. Simultaneously, it may be preferred to have a relatively short range to help prevent unintentional scanning of Tag 100 by passersby or scanning secretly without the user's knowledge, for example, scanning while standing behind the user carrying Tag 100.

Tag 100 preferably includes a write antenna 130, which permits data to be transmitted to and written onto Tag 100. Namely, the user may scan Tag 100 with his Device and choose a file to upload into the Tag Folder. The Device transmits the file to the server to be saved as a File Content in the Tag Folder, preferably via Wi-Fi or wireless (or wired) data connection. Alternatively, the user may use a web browser to upload the file onto the server. Data is transmitted via write antenna 130 to save a Tag Pointer onto Tag 100 for the saved File Content, wherein the Tag Pointer refers to the location of that File Content. Whereas the example provided refers to a file, it is to be understood that the user may save a pointer to any Tag Content, including Pointer Content and Information Content.

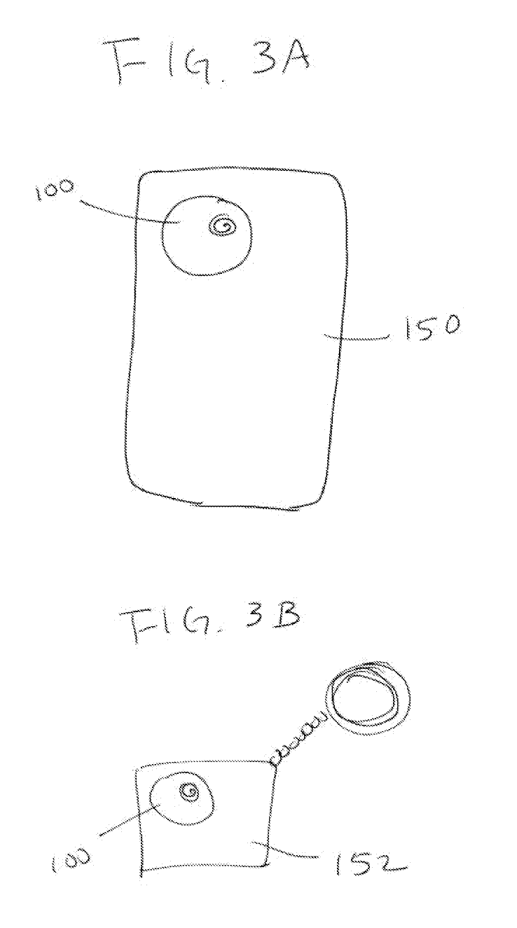

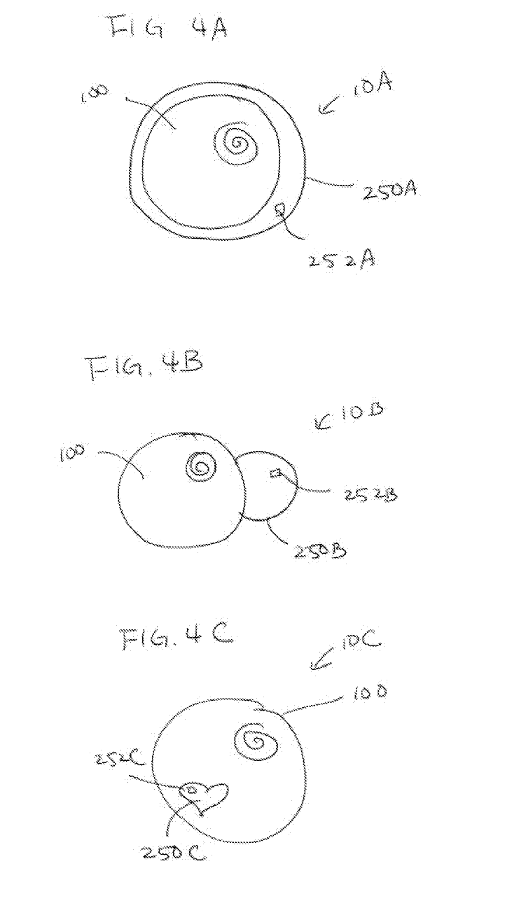

Referring to the embodiment shown in FIG. 2A, Tag 100 preferably has an adhesive portion 112, via which Tag 100 is adhered to a backing 200. Adhesive portion 112 may have an adhesive, like a sticker, or other adhesive properties. For example, Tag 100 may adhere to a surface via static cling or other means without the use of adhesives, like certain cell phone screen protectors currently available. A backing 200 preferably covers adhesive portion 112 of Tag 100, and once backing 200 is removed from Tag 100, Tag 100 may be adhered to a desired surface. Non-limiting examples of such surfaces include cell phones, cell phone cases, books, wallets, jewelry, shoes, clothing items, keychains, water bottle, to name a few. Preferably, Tag 100 is adhered to a portable item, which may facilitate sharing of the Tag Content. FIGS. 3A and 3B show Tag 100 adhered to a cell phone case 150 and a keychain 152, respectively.

In the embodiment illustrated in FIG. 2B, write antenna 130 is located on backing 200, rather than on Tag 100, and Tag 100 and backing 200 combined form a tag combination 10. When tag combination 10 is intact, having both Tag 100 and backing 200, the user may write to Tag 100 and the associated Tag Folder on the server. In such an embodiment, once backing 200 is removed from Tag 100, write antenna 130 is also separated from Tag 100, and thus, Tag 100 no longer receives data transmissions and the corresponding Tag Folder is closed and prevented from having content added thereto. Alternatively, the Tag Folder may be closed and Tag 100 may be prevented from receiving content using software, which is the preferred method for Tag 100 shown in FIG. 1, having an incorporated write antenna 130 that is not removed. When Tag 100 is scanned by a Device after Tag 100 is “locked” via software or by removing backing 200, the Device may send a signal to the server that Tag 100 has been locked, indicating that the associated Tag Folder should be prevented from receiving new content. Such a signal may be sent once, the first time Tag 100 is scanned after being locked, or each time Tag 100 is scanned, as described in further detail below, as a matter of application specific design choice.

Once the user wishes to close Tag 100 to prevent any further Tag Content to be saved in the Tag Folder, the user may do so by initiating the appropriate software or application, for example, from a Device such as a cell phone or other mobile device, a computer or online via a webpage, portal or connecting to a server via which the user can control Tag Folders. Or, if write antenna 130 is removable from Tag 100, the user may remove the removable portion having write antenna 130 from Tag 100, after which the user is left with a Tag 100, which is readable but not writable.

In accordance with a preferred embodiment, Tag 100 that has been locked may be “unlocked” to permit Tag Content to be saved into the associated Tag Folder. Tag 100 may be unlocked via a Device such as a cell phone or other mobile device, a computer or online via a webpage, portal or connecting to a server via which the user can control Tag Folders. The user may be required to solve a puzzle in order to unlock Tag 100, for example via an application on a mobile device.

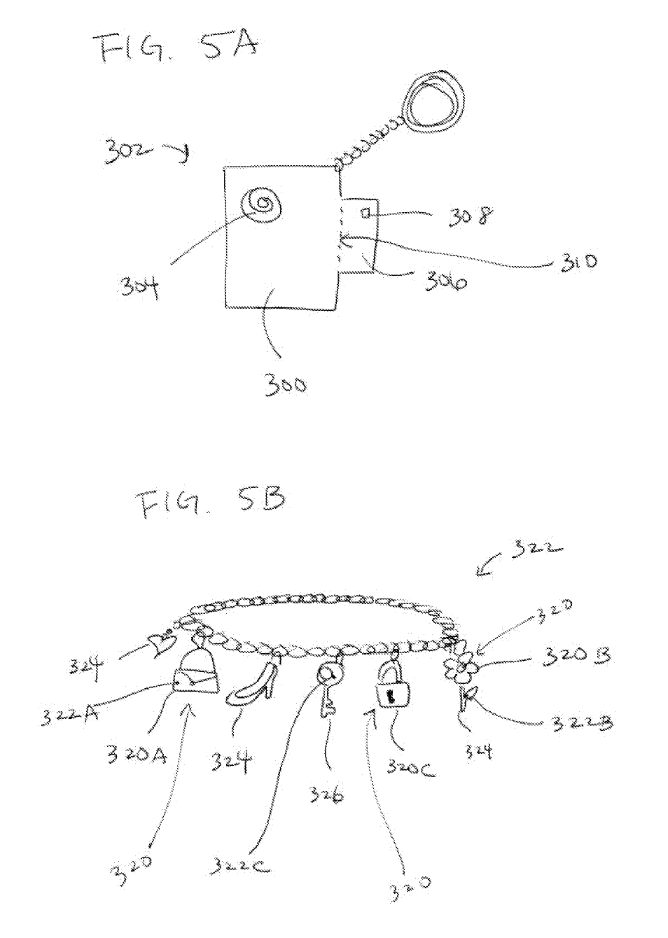

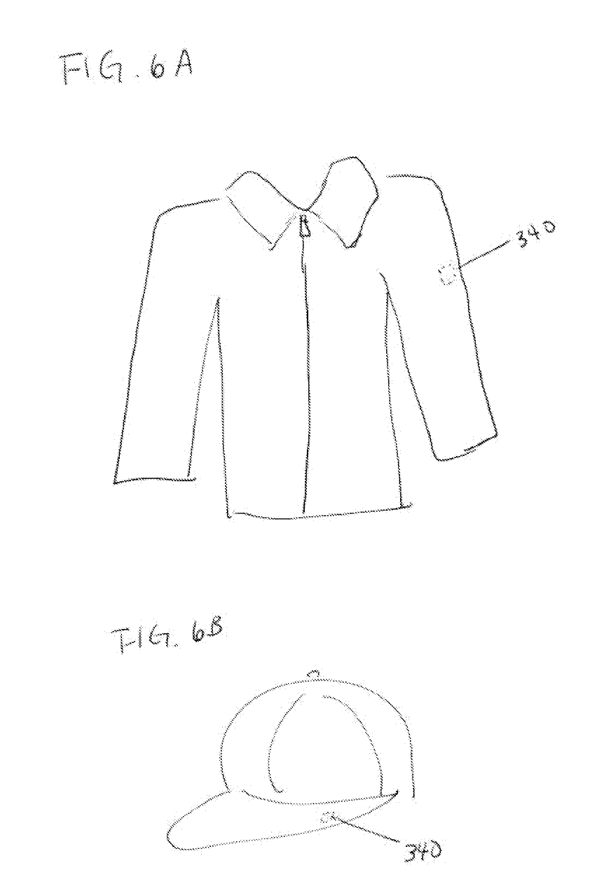

Reference is made to FIGS. 4A to 4C, wherein alternate embodiments of tag combinations 10A, 10B, and 10C are shown having removable portions 250A, 250B, 250C having a write antenna 252A, 252B, 252C, respectively. FIG. 4A shows a tag combination 10A wherein the removable portion 250A having a write antenna 252A is a tag cover 250A adhered onto the surface of Tag 100. Whereas tag cover 250A is shown as being larger than Tag 100, it is to be understood that variations in size and shape of tag cover 250A are contemplated without deviating from the scope of the invention. FIG. 4B shows a tag combination 10B wherein the removable portion 250B having a write antenna 252B is adjacent to Tag 100. FIG. 4C illustrates a tag combination 10C wherein the removable portion 250C having a write antenna 252C is a smaller adhesive element adhered onto the surface of Tag 100, like a design. Preferably, removable portion 250A, 250B, 250C adheres to Tag 100 and/or other surface onto which it is placed, by static cling or other means such that little or no residue is left behind once removable portion 250A, 250B, 250C is removed from Tag 100. These embodiments of tag combination 10A, 10B, 10C may be adhered it its entirety onto a surface, so that the user may continue to write to Tag 100 after sticking it onto a surface. Such embodiments may be preferred, so that the user may stick on tag combination 10A, 10B, 10C onto a cell phone case or other portable item, rather than carry tag combination 10 in his wallet, bag, folder, etc., in which case he must remove it to scan, and put it back after scanning it. Likewise, an embodiment of Tag 100 having write antenna 130 within tag 100, as shown in FIG. 1, may be preferred.

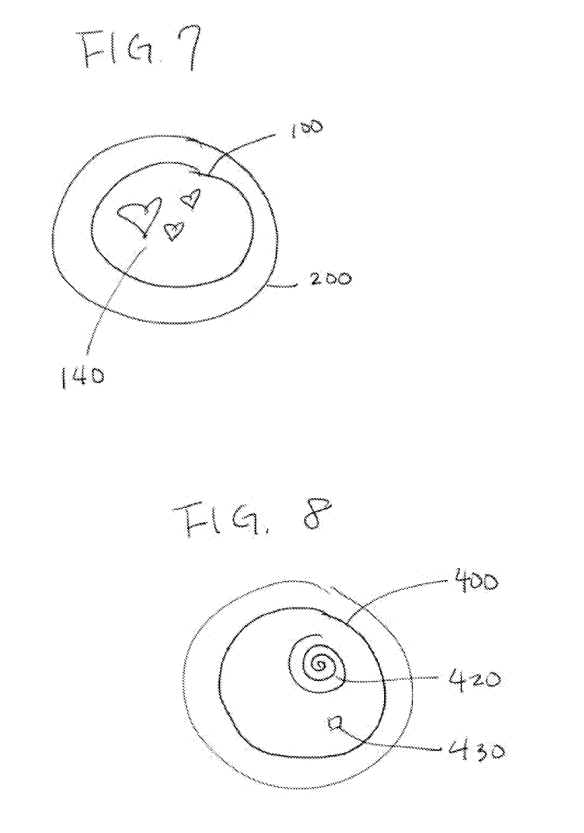

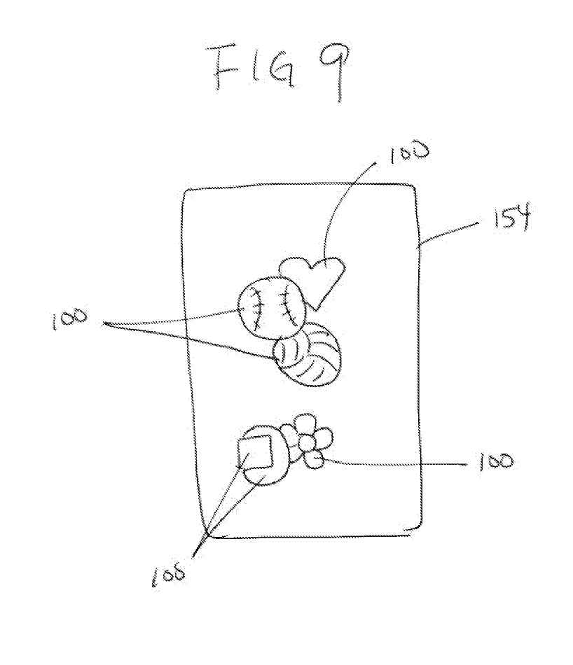

Preferably, a user may upload content to the Tag Folder associated with Tag 100 within a specified period of time after scanning Tag 100 or within a specified distance from Tag 100. By way of non-limiting example, the Tag Pointer for the Tag Content may be stored in the Device, for example, in the phone application, for a specified period of time, ranging from 1 second to 1 minute, more preferably between 5 seconds and 10 seconds. A user may take a video and then scan Tag 100, whereupon the video is tagged with the location of Tag 100. The user may also upload such video or other content to the Tag Folder associated with the scanned Tag 100 or access Tag Content that have already been saved into Tag Folder.

Whereas the embodiments described above refer to Tag 100 having adhesive portion 112 to permit Tag 100 to be adhered to a surface, it is to be understood that other variations of Tag 100 are contemplated. Tag 100 may have any structure and physical characteristics, or may be incorporated with any structure or item, such as a keychain, jewelry, a cell phone case, a bag, a clothing item, to name a few non-limiting examples. Such structural forms are not limited to Tags 100 having an integrated write antenna 130, but also for Tags 100 having a removable write antenna 130. FIGS. 5A to 6B illustrate a few non-limiting examples of the form Tag 100 having a removable write antenna 130 may take.

FIG. 5A illustrates a keychain 302 comprising a Tag 300 having an NFC element 304, more specifically an NFC integrated circuit and inlay antenna, attached to a removable portion 306 having a write antenna 308, which may be detached from Tag 300. For example, perforations 310 may be provided between Tag 300 and removable portion 306, to facilitate removable portion 306 being snapped off from Tag 300. Removable portion 306 may be produced from the same material as Tag 300. Alternatively, removable portion 306 may be produced from a different, preferably cheaper material, such as plastic, fabric, paper, etc.

FIG. 5B illustrates an embodiment of the invention in which the tag is a charm tag 320 on a bracelet 322. As shown, charm tags 320A, 320B, 320C may be hidden among charms 324 on bracelet 322. Alternatively, all the charms on bracelet 322 may be charm tags 320. The write-enabling element may be provided in a variety of ways. For example, write-enabled pin 322A may be integrated within charm tag 320A. Write antenna 322B may be included in removable portion 324 detachable from charm tag 320B. Alternatively, write antenna 322C may be provided in a separate write antenna charm 326 corresponding to charm tag 320C, wherein removing the write antenna charm 326 would suffice as “removing” the write antenna from charm tag 320C. Alternatively, the removable portion may be a protective coating or a removable sticker, which may be peeled off or otherwise removed, as described above.

FIGS. 6A and 6B illustrate embodiments of the tag 340, which is a part of an article of clothing, namely a jacket and a cap, respectfully. Other non-limiting examples of embodiments contemplated include books, magazines, water bottles, coffee cups, and merchandise tags, to name a few.

Write antenna 130 may be unique to each Tag 100, or it may render writable all Tags 100 within range, which have not been locked, as a matter of application specific design choice. In accordance with a preferred embodiment, the application on the phone can communicate with all Tags 100 that are within range and have not been locked.

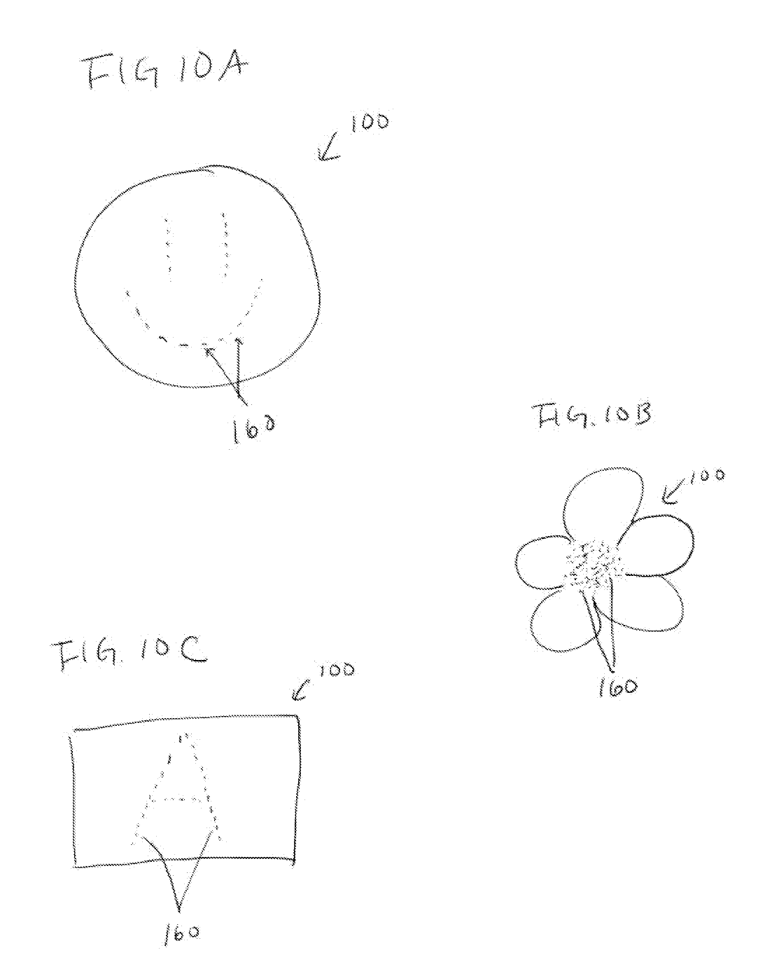

Referring to FIG. 7, Tag 100 may have an image 140 thereon. Preferably, a variety of images is provided for Tag 100, so that the user may choose the image which appeals to him. By non-limiting example, Tag 100 may have an image of a sports team logo, scenery, cartoon character, pattern, or an image selected by a user and printed on Tag 100. A user may upload or otherwise transmit a photo or other image to the manufacturer or vendor to be printed on Tag 100 for personalized Tags 100. For example, a company may use tags 100 having its logo printed thereon as a marketing item, or a person may choose to have a photo of their child on Tag 100. Alternatively, a couple may send out tags with their wedding date as a save-the-date, perhaps with information on the wedding, links to the venue, photos of them, and other content the couple wishes to share. Tag 100 may either be in a writable state, so that the recipient may write to Tag 100 himself, or locked, so that only the saved wedding content is accessible.

Having images may not only be more pleasant to look at, having a variety of images may facilitate differentiating between Tags 100 a user has. Furthermore, providing an image may help camouflage Tag 100. People may not know that Tag 100 can be scanned in order to gain access to content on a server, but may think it is just a sticker, keychain, charm, etc.

Reference is made to FIG. 8, wherein a tag 400 includes an NFC element 420 and a write-enabled pin 430, rather than a write antenna described in the embodiments above. In this embodiment, write-enabled pin 430 functions similarly to write antenna 130 in that it transmits data to Tag 400 so that Tag 400 can be written to. When the user wants to lock Tag 400, he may physically break write-enabled pin 430 to prevent Tag 400 from being written on thereafter, and the corresponding Tag Folder on the server from receiving any new content.

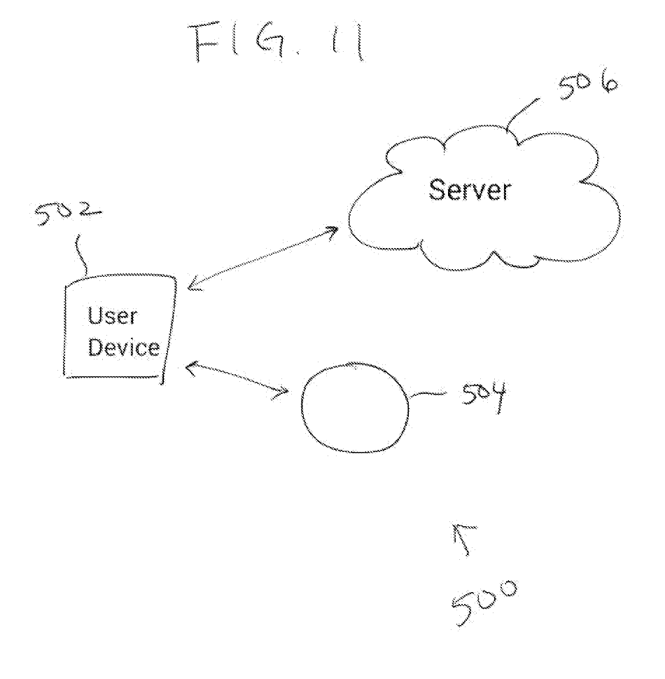

In accordance with a preferred embodiment of the invention, a plurality of Tags 100 may be stacked on top of each other without losing the ability to be scanned. For example, if Tags 100 are sticker tags each having an adhesive portion 112, they may be adhered on top of each other or overlap with each other, as illustrated in FIG. 9. In the embodiment shown, a plurality of Tags 100 is adhered to an item 154, such as on a cell phone case, a book, a bag, a jacket, etc.

Frequency modulation jitter may be used, or each antenna may have a unique characteristic to be distinguishable from the others, or a read and halt method made be used to read overlapping tags. A frequency modulation jitter method may require the ability to control the mobile device's RF characteristics, and therefore, the read and halt method may be more preferred. A read and halt method comprises reading a tag, sending a command to halt the tag, after which Tag 100 will put it in an idle state for a given period of time, for example between 3 to 5 seconds, and then moving on to the next Tag 100. More specifically, read and halt works as a Device reads through a plurality of Tags 100. The device identifies one tag, reads and writes to it, and then puts it into an idle state by telling the tag to turn off for 3 to 5 seconds, as it identifies and reads other tags. Preferably, the device can read at least 5 tags per second, more preferably between 10 to 15 tags per second. Frequency modulation may be the preferred method for reading a higher number of tags stacked on top of each other, wherein a modulation jitter is used to send different frequencies to pick up signals from antenna positioned on top of each other.

When a plurality of stacked Tags 100 is scanned by a Device, an option may appear on the Device to select which Tag 100 to read. For example, the list of Tags 100 may appear as a list of Tag IDs or tag names assigned to each Tag 100 by the user, icons, or other means for identifying each Tag 100. When a user clicks on or otherwise selects a specific Tag 100 from the list, a new screen may appear, listing the options available. For example, the user may be given the option to save content to or open Tag Content in the corresponding Tag Folder.

Tag 100 may further include an LED (light-emitting diode), preferably a nano LED, more preferably a printable LED. An example of such a printable LED is available from NthDegree (www.nthdegreetech.com). Printable LEDs are generally low power, low cost, and can be printed with a multiple layer printing process. These LEDs are typically microscopic in size, for example, the size of white blood cells, and thus, are not visible to the naked eye until they are lit up. Therefore, the printable LEDs may provide Tag 100 with a design, lettering or other visual arrangement that appears when activated. FIGS. 10A-10C illustrate examples of Tag 100 having printable LEDs 160 arranged in specific designs. The designs may be preset or it may be requested by a consumer, after which the LEDs 160 are printed in the requested design. Preferably, the printable LEDs 160 harvest their power from the antenna in the NFC element 120.

Preferably antenna 122 generates an electric charge that may be managed by the NFC chip (integrated circuit), preferably inside an inlay in which antenna 122 is embedded. The electrical charge generated by antenna 122 may be used to power the LED. The LED may be turned on or off by the user, or automatically in certain situations. For example, if Tag 100 is placed on a cell phone case, the LED may light up when the phone receives a call, text, alert, etc. Preferably, the user decides in which situations the LED lights up. Tag 100 may include more than one color LED, so that a different color LED lights up in different situations.

### System

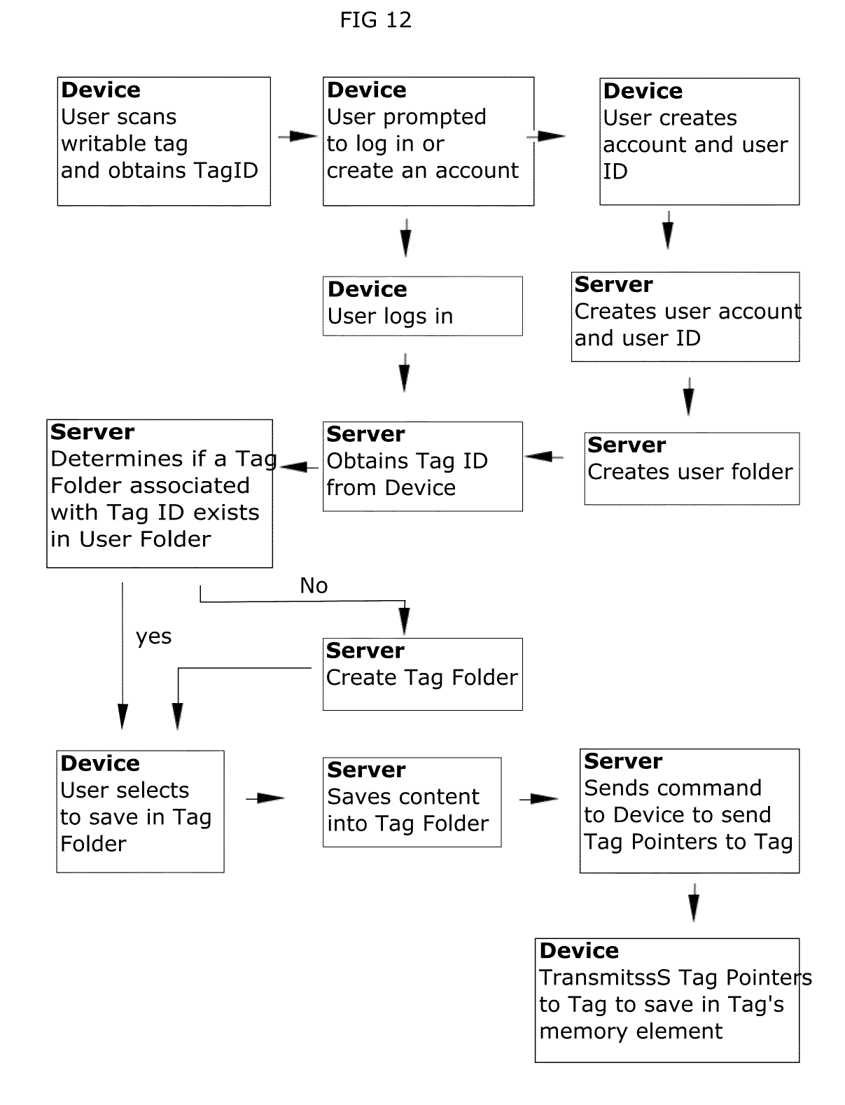

Referring to FIGS. 11-12, certain exemplary embodiments of the system are described herein. As shown in FIG. 11, an embodiment of the system 500 includes a user Device 502, a writable tag 504 and a remote server 506. Using user Device 502, preferably via a mobile application, a user scans writable tag 504 to access information on the tag 504, such as the tag ID. Writable tag 504 described herein includes a write antenna or a write-enabled pin, to which data can be written onto its memory element.

Initially, if it is the first time the user scans the writable tag 504, the user is prompted with an option to log in or create a new account. It is preferred to have user accounts to identify and keep track of Tag Content for each user saved onto the server, but it is not necessary. If the user creates a new account, a user ID is assigned to the user. Alternatively, the user ID may be chosen or specified by the user. A user may create an account via a web browser, the user mobile device 502 or any other suitable means.

A user folder for the user ID is preferably created on the server, wherein the information collected from the user, along with all Tag Content received for one or more writable tags 504 will be saved. The user may create a user profile or save other user information, which is preferably saved in a sub-folder within the user folder. Preferably, if the user account is created via the user mobile device 502, a command is sent to the server 506 through a server API (application programming interface) from the mobile application running on the phone to automatically create a user folder.

Once the user is logged in, user Device 502 transmits the tag ID and any available tag information, which was retrieved from writable tag 504, to server 506. A Tag Folder is created on the server as a sub-folder within the user's folder. Preferably, a tag profile is created, either automatically or by the user, to include information regarding writable tag 504. The tag profile information may be saved in the Tag Folder, preferably in a sub-folder within.

The user may then select the content to be saved into the Tag Folder. It is to be understood that the content may be a File Content, a Pointer Content, an Information Content as described above, or any other content that can be saved into the Tag Folder. If the content is a File Content located on user Device 502, the selected file is uploaded onto server 506 and saved in the Tag Folder. The user may also capture an image, video, record sounds or create an image or document using the mobile application, after which the user may choose to save such file to the Tag Folder as a File Content.

As described above, the content may be a Pointer Content, which points to content located elsewhere. For example, if the content is on another server, such as YouTube®, Facebook®, Instagram®, a music site, etc., a Pointer Content to the content is transmitted to the server 506 and saved in the Tag Folder. The content may be a selection of apps, websites, music, movies, etc., in which case a Pointer Content to such apps, websites, music or movie database, app or website, is transmitted to the server 506 and saved in the Tag Folder. The content may also be Information Content regarding the user, such as the user's name, phone number, email address, etc. which the user wishes to share or become available when somebody scans tag 504. The server 506 preferably has an API for other applications, and manages key systems and other applications.

Each time the user scans a new writable tag 504, a new Tag Folder is created for each new writable tag 504, the Tag Folder having that new writable tag's information, such as its Tag ID. Therefore, the user may choose in which Tag Folder to save certain content by scanning the associated writable tag 504. The new Tag Folder is preferably created as a sub-folder in the user's folder. Alternatively, rather than being saved as sub-folders in the user folder, the Tag Folders may be saved elsewhere on the server, either purely based on the tag information, such as Tag ID, or with the tag information along with user information. Preferably, user information is associated with the Tag Folder, so that if the user logs in without scanning a Tag 100, the system can determine which Tag Folders to display to the user. Alternatively, the Tag Content saved by the user may be saved directly onto the server or in folders other than a Tag Folder, without deviating from the scope of the invention. Each Tag Content for a specific Tag 100 have Tag identifying information associate therewith, such as the Tag ID, to facilitate retrieval of such Tag Content whenever the specific Tag 100 is scanned.

In an embodiment of the invention, the user may access his Tag Folders from a computer or other device via which he can connect to the server, for example, via the Internet. The user may rename the Tag Folders, the Tag Content, copy or move Tag Content from one Tag Folder to another, etc. without the use of a mobile device 502 and the physical writable tag 504. Preferably, the Tag Folders and Tag Content will maintain its association with the Tag Pointer, so that when a user scans the Tag 504 to upload content to or access content in the Tag Folder for the Tag 504, the appropriate Tag Folder and Tag Content will be accessed, even if the Tag Folder or Tag Content was renamed or moved.

Once the writable tag 504 is locked and read-only, for example, by software or if the write antenna is removed or the write-enabled pin is broken, a command is preferably sent to the server to close the Tag Folder. In response, the server closes the Tag Folder corresponding to Tag 100 that was scanned, and content may no longer be added to the Tag Folder. In one embodiment, once a folder is closed, it cannot be altered, including deleting and moving content. For example, if Tag 100 that has been locked is scanned, the scanning Device retrieves the Tag ID, Tag Pointers, and an indication that Tag 100 is locked. The Device may transmit a command or other signal to the server to close the Tag Folder, to prevent new content from being added into the Tag Folder. This command may be sent once each time Tag 100 is locked, the first time Tag 100 is scanned after being locked, or it may be sent each time Tag 100 is scanned.

In accordance with an embodiment of the invention, if Tag 100 is unlocked, the command to close the Tag Folder is not sent to the server, or alternatively, a command to reopen the Tag Folder may be sent to the server. Subsequently, the Tag Folder is reopened and changes can be made thereto, as if it were never closed.

Preferably, the person scanning Tag 100 is presented with a list of Tag Content in the Tag Folder, after which the person may select a specific Tag Content by selecting its Tag Pointer. The Device transmits a signal to the server indicating the selection, and the Tag Content is transmitted back to the Device in response thereto. For example, a File Content may be transmitted to the Device for downloading or viewing, or a webpage or application may be opened to access the appropriate content. If the content is a File Content that may be downloaded, the person scanning Tag 100 may be given the option of downloading the file onto the Device or viewing the content of the file. Preferably, the Tag Pointers in Tag 100 and thus the Tag Content are accessible by the Device scanning Tag 100, regardless of whether or not Tag 100 is writable. Therefore, the user need not lock Tag 100 before he can share the Tag Content. In accordance with a preferred embodiment, the person scanning Tag 100 to retrieve the Tag Content is not required to log in or have an account, thus facilitating the sharing process. Rather, upon scanning Tag 100, the scanning Device displays the list of Tag Pointers, referring to Tag Content saved in the Tag Folder of Tag 100. Hence, the user may also access the content without logging in. However, it is preferred that the scanning Device has the applicable mobile application installed therein, to scan and/or access the Tag Pointers.

An embodiment of the invention grants the user the ability to choose which Tag Content is to be shared with others, and which Tag Content is accessible only to the user after logging in. For example, the user may create a sub-folder within the Tag Folder into which the user may save Tag Content that is not to be shared. Alternatively, the user may indicate for each Tag Content whether or not it is to be shared, either when such Tag Content is first saved into the Tag Folder, for example, via a prompt, and/or at a later time. For example, if the user clicks on or otherwise selects a specific Tag Content, he may be prompted to choose whether to view, delete, or modify the settings for that specific Tag Content.

The user may also create multiple folders having different access rules or set up permissions for different people in the server. For example, the user may create a public folder that anyone scanning the Tag can access, a folder for close friends, and a folder that can receive content from others. Certain folders may be protected by password or other security means, so that only persons who are given the password may access them. When the tag is scanned, a list of all folders may appear, and selecting a password protected folders may result in a prompt to enter the password, without which the person is not granted access to the folder. Alternatively, only the public folders may appear until the person enters a special code, after which the hidden folders will appear. Another option is to provide a list of users with permission to access certain folders, such that if a person on the list scans the tag, all the folders for which he is granted access appears. Therefore, if someone not on the list scans the tag, only the public folders appear. The list may comprise a list of names, user IDs, or other identifying information. For example, the list may include tag IDs, wherein Devices having a tag ID on the list will have access to certain folders. Such embodiments in which multiple folders having different access rights may be preferred for use with tags that are placed in public locations, as discussed in further detail below.

Preferably, both users and non-users alike utilize a mobile application for the system to scan Tag 100 and access the associated Tag Contents. Tag 100 may be scanned in-app (via the mobile application's interface), via another suitable application, or automatically, if the Device is set to automatically scan NFC tags within range. If Tag 100 is scanned not in-app, the system's mobile application is preferably launched on the Device to either display the Tag Pointers or prompt a log-in.

A log sub-folder may be created within the Tag Folder to contain the history log of tag 504. Every time tag 504 is accessed, a log may be kept and saved in the log sub-folder. The log may include details regarding the interaction between any scanning Device and tag 504, for example, which Device scanned tag 504, when and where, what actions were taken, etc. Preferably, this log may be kept even after tag 504 is rendered read-only.

### Shared Experience System—Geotagging

A system for networking, preferably for sharing experiences is described herein, comprising a plurality of tags 100 placed around the world by one or more users. Tag 100 is scanned by a user who initiates it, creates a tag folder and places the tag in a particular location. Therefore, anyone else who goes to the location and scans Tag 100, preferably using the same mobile application, will have access to the tag folder and/or any permitted subfolders, and according to the authorization granted, may upload, access and/or download content from/to the folder. Preferably, a user may save content into the tag folder only when he is in the vicinity of Tag 100, more particularly within a specified distance, for example, within the range of write antenna 130 as described above. Therefore, only people who were at the specified location can upload content and only while they are at the location. However, the users preferably can access the content from anywhere after having scanned the tag once. By way of non-limiting example, once a user scans Tag 100, the associated tag folder is saved into that user's account for future access. Thus, even after leaving the location, the user may access content saved by others after him as well. Therefore, years later, the user may get a notification that someone added content to that tag folder, and he can access the content to see what the most recent user to scan the tag uploaded. The system may serve as a time capsule of sorts, via which users can watch videos, view photos, messages or other content saved onto the tag folder by people years ago from the same location.

Preferably, the users with access to the same tag folder are able to communicate with each other, for example, via a chat room within the mobile application used for scanning the tags. Alternatively, the users may use a different application, software or service such as Facebook® to communicate. In accordance with an embodiment, the initiating user creates a “room” associated with a tag, such as a chat room or other interacting means for users who scan the same tag. By placing a tag at a particular location, only users who go to that location will be able to scan the tag and thus enter the room, after which such new user will be able to communicate with other users who had previously scanned the tag. For example, a first user places a tag on the peak of Mount Everest and creates a room associated with the tag, and calls it “Everest.” He uploads photos and videos of himself at the peak. Subsequently, a second user climbs Mount Everest and scans the tag. He will be added to the room “Everest” via which he may communicate with the first user. He may access the photos and videos that the first user had uploaded, and upload some of his, which both he and the first user may access. The first and second users may message each other in the room. For example, they may discuss the best time or route to descend, what other mountains they climbed, locations of other tags, etc. As more and more people reach the top of Mount Everest, the number of people (“brothers”) within the room “Everest” will grow, and a community built. It is to be understood that the term “brother” is used as an exemplary term for members of the room or community, and is gender-neutral.

A network web may be provided for the users to see how a user is related to his brothers, i.e., which of the user's tags each brother scanned, as well as which of the brothers' tags the user scanned. It may be entertaining to see how many brothers a user has in different countries. The system may also provide a map of where the user has placed tags, where the user's brothers are located, based on their own user profile, etc. Preferably, each user can choose the level of disclosure of personal information, for example, permit brothers to see his entire profile, parts thereof or not at all, or see only where he scanned the brothers' tags, etc. Once a stranger becomes a brother with a user, the user and/or new brother may share the locations of his other tags.

### Game System

A game system is provided utilizing one or more tags and a server, wherein users may scan the tags to access games and connect to other users. Preferably, users will place tags in various locations around the world, and use the system to show others where they have been, as well as communicate with others who have been or in the future, go to the same locations as described above, as well as use the system to play games with each other.

A first user may program a tag with a unique Tag ID profile and specified settings, and place it at a location, for example, a bus stop, on a ski lift, at a park, at a coffee shop, bar, restaurant, mall, etc. Then, a second user with the appropriate mobile application may scan the tag, whereupon the game settings dictate what happens next. The second user may be granted points for scanning the tag as a part of a broader game wherein users collect points for each tag scanned. Scanning each tag may grant the user the same number of points, or the number of points granted may vary by tag and location, for example, the more difficult the tag is to find, the more points are granted. Scanning certain tags may grant points each time a user scans it, for example, up to once a day, once a week, etc. whereas scanning certain tags may grant points only once per tag.

Depending on the settings provided by the first user, the second users may be able to save content into the associated tag folder of the tag, access content in the tag folder, be added to a chat room or community to communicate with others who have scanned the same tag, etc. A tag scavenger hunt-type game may be provided wherein users try to find all the tags, and scanning one tag may result in obtaining a clue for the location of another tag, for example, a riddle, a photo, etc. Preferably, the first user, who had placed the tag in the location, can see who scanned the tag.

A person may leave a cookie trail of where he has been by placing tags at various locations. For example, a famous skater may place a tag at every skate park he goes to. A celebrity may leave a tag at every vacation site she visits. They may post, on a social networking service (SNS) site, such as Facebook®, Twitter®, Instagram®, Google+®, etc., of these locations, and their fans may try to locate these tags and scan them themselves to see the content that the celebrity saved onto the associated tag folder. The skater may have uploaded a video of him doing a special trick, or giving tips, that are accessible only by people who have been to that location and scanned that tag. An actress may have uploaded a selfie taken from the location. A company may place tags at various locations, each having a discount code, a voucher for a free gift, points for a rewards or status program, etc. A hotel chain may pay a celebrity to place tags in each of their locations and upload exclusive content as an advertisement program. An airline may have a tag at the entrance to their airplanes so that each time a user scans the tags, he obtains mileage or points for a rewards or membership program, the WiFi code for the flight, information regarding the flight crew, or whatever the airline decides to share. An advertisement company may use the data regarding which tags a user has scanned to tailor advertisement to that user. How the system is used, for what purpose, what content is shared and/or saved in the tag folders, and other variations are contemplated without deviating from the scope of the invention.

A community of people who have scanned the same tag may be formed, preferably on an online SNS site, such as Facebook®. The user who placed the tags may group his tags to create a joint community for a group of tags, so that everyone who scanned any of his tags within the same group will be added into the appropriate Facebook® group or other community. For example, the user may group his tags placed on ski slopes together and call the community “Snow Addicts,” and group his tags placed at beaches together and call the community “Beach Bums.” Thus, a person who scans any of his tags on ski slopes will be added to the community “Snow Addicts,” whereas a person who scans any of his tags at beaches will be added to the community “Beach Bums,” thus creating interest groups. The groupings may be based on any factor, such as geographic location, type of location (family friendly, romantic, etc.) or for no reason whatsoever, as determined by the user creating the groups.

The system may provide a status program of its own, preferably viewable online. For example, every time a user scans a tag, he may receive a status upgrade, or points. The number of times he receives the upgrade or points may depend on the setting provided for each tag. A user may receive points once per tag or each time he scans a tag, but limited to once per day, once per hour, once per week, etc., according to the setting for the tag. Additionally, scanning certain tags may mark an achievement (i.e., climbing Mount Everest, going down a difficult ski trail, etc.) and a virtual medal or other award may be granted for each achievement. It may be preferred for certain tags, such as a tag placed on a ski trail, to have a relatively wide range in which the tag can be scanned, so that if a phone with the mobile application running passes by the tag, the tag will automatically be scanned even without the user coming to a stop near the tag. For example, a user may turn on the mobile application on his phone before going down a ski trail. As he skis down the slope, once he enters the zone within which the tag is readable, the phone scans the tag. Because he may be traveling at a high speed, it may be preferred for the tag to have a wider range to give the device sufficient time to scan the tag.

The system may also provide a method for users to upload content, such as photos and videos, directly in app onto a social networking service (SNS) such as site, such as Facebook®, Twitter®, Instagram®, etc.

### Networking Program

A system in accordance with an embodiment of the invention provides a program for networking Generally, a user places tags in various locations and/or items. Every time somebody scans one of his tags, that person joins his network, for example, as a “brother.” Preferably, the system includes relationship tags, such as friend tags, family tags, tags for specific groups, etc., which the user may distribute to different people. If someone with one of the user's relationship tags scans one of the user's tags, they can become “brothers” in addition to whatever relationship the relationship tag specified.

A game may track how many brothers a user has, wherein obtaining a certain number of brothers is considered an achievement, and people may compete with regard to their respective status in the game or program, their number of brothers, etc. Brothers with additional relationships may be worth more points, special points, or have other benefits.

According to an embodiment of the invention, the game or program is associated with an SNS to post updates or accomplishments. For example, the game or program may post onto a user's Facebook® page when the user gains a celebrity brother.

### Tag-it

Another embodiment of the invention includes a game or program in which a tag is passed around from person to person. An example of how such an embodiment works is illustrated in the flowchart of FIG. 12. As shown, a first user purchases or otherwise obtains tags. The first user creates a user account on the server and creates and sets up a room, including for example, the room's theme, an expiration date if any, parameters, and filters such as user age, gender and level of profanity permitted in messages shared in the room.

The first user encodes the room for a single tag or multiple tags, according to the preference of the first user. The first user then gives the tag to a second user, who may further encode the room for another tag or multiple tags. The second user gives the tag to a third user, who may also encode the room for another tag or multiple tags. Alternatively, one of the users within the chain may choose to place the tag at a location or object, rather than give it to another user.

The first user, who created the room, is preferably the administrator of that room and controls the room, by way of non-limiting example, determining its profile, whether to close, pause or open the room, whether to remove a user from the room, what criteria a user must fulfill to enter or remain in the room, what the room includes, what users may do in that room, etc. Examples of what users may do in the room include chat via messages (like a chat room), conduct video/voice chat, share content such as photos, videos, audio files, documents, notes, links to websites, etc. The first user may set the room so that the identities of the users remain anonymous unless expressly disclosed by users within the room.

In accordance with an embodiment of the invention, the tag is a sticker onto which the first user may print an image or text, write or draw. For example, if the user wishes to create a community of horror movie buffs, he may put “Horror Movie Buffs” on the tag prior to passing it around or placing it somewhere or on something. Then the subsequent users will know what kind of a community they'd be joining by scanning the tag.

The creator of the room may permit other members of the room to associate other tags to the room, which may facilitate in expanding the room. For example, if the creator associated five (5) tags to the room, and the second person associates three (3) of his own tags to that room, the room will now add all the users who tagged any of those eight (8) tags. Thus, each time a new user scans any of those eight (8) tags, he may associate his own tags to that room. A user who scans a tag may be able to join the room at any time thereafter, or he may be required to join the room while he is within range of the tag. This may be determined by the system or the creator of the room. Members of pre-existing rooms associated with tags added by non-creator users may be given the option of joining the room or joined automatically, preferably dictated by the creator's room settings.

An SNS community may also be created, for example, a Facebook® group, consisting of all the people who had scanned the tag(s) to which the room was encoded. The community may be provided with a directory of the locations of all the tags to which the room was encoded, should the members desire to find them. Preferably, a broader umbrella community is provided, within which the communities associated with tags exist. In accordance with an embodiment of the invention, once a user registers with a system, he joins the umbrella community. Once he scans a tag, he joins the community associated with said tag. The umbrella community may include an index of interests or topics, event or geolocational features, which users within the umbrella community may view or browse, depending on the settings for each community. Some communities may be set up so that people may join the community or communicate with members of such community without actually scanning the associated tag.

The first user may also decide what information to retrieve from each subsequent user who scans the tag. For example, the geographical location of the users may be saved onto the server when the users scan the tag. The system may also provide a map view, illustrating where and by whom the tag(s) to which the room was encoded were scanned.

Preferably, a user can share content in its user folder via a network on the server of the system, via an SNS or other suitable means. For example, a user may post regarding an achievement or a location visited on Facebook®. Users who are connected by scanning a common tag, or who otherwise became “brothers” as described above, may choose to become “friends” on Facebook®, follow each other on Twitter®, add each other into circles in Google+®, meet in person, or whatever they choose to continue and develop the relationship. Thus, the system may be a useful networking system.

An embodiment of the invention may be used to facilitate or enhance experience at events. For example, a user may place a tag at an event, such as Comic-Con®. The user may choose to announce via an SNS that he is placing a tag, where the tag will be located, what functions each user who scans the tag will be granted, etc. Those who scan the tag “check in” and enter a chat room via which they may chat and share tips, experiences, etc. with others at the event. For example, a user may let everyone in the chat room know about a special guest, which lines are shorter, which booth is giving away free gifts, etc. In accordance with another embodiment, a user posts on Facebook® that he is a Yankees® fan and that he will be going to a Yankees® game on a particular day, as well as where he will place or placed the tag, thus inviting other Yankees® fans attending the game to scan the tag and keep in touch throughout the game, sharing photos or videos, comments, etc. For such event-specific uses, the user may choose to close the room after the event ends. Alternatively, he may choose to leave the room active so that members in the room may continue to keep in touch. The user may program the tag such that it is no longer scannable after the event ends, while leaving the room active, so that the members may continue interacting, but no one can join the room by scanning the tag at a later time. The user may also close the room after the event and reopen it for a similar event (i.e., San Diego Comic-Con® followed by New York ComicCon®; a subsequent Yankees® game).

An exemplary use of an embodiment of a tag and system includes placing a tag on an event poster. For example, a first user may purchase a tag, create a room on the server of the system and place the tag on a poster for Comic-Con® in a local comic book store. People interested in Comic-Con® scan the tag and enter the room to discuss the event before, during and/or after, according to the room setting provided by the first user.

An embodiment of the invention permits users to maintain anonymity. They may create an avatar and not share personal information. For example, a boy may open a room associated with a tag and stick the tag on an item belonging to a girl he has a crush on. If the girl scans the tag, she will enter the room, in which the two can communicate. The boy can then communicate with the girl anonymously, perhaps until he builds up the courage to tell her who he is or speak to her in person. The girl can have one or more friends scan the tag and join the room, creating a larger community. The boy may permit the new friends to remain in the room or kick them out. Additionally, as the room's administrator, the boy may close the room whenever he wants.

Preferably, a user who enters a room by scanning a tag can choose to leave the room at any time. The exit may be final, and the user may not re-enter the room unless he scans the tag again, or he may be permitted to re-enter whenever he wants. The user who created the room may determine the rules for re-entry.

Other alterations may be made without deviating from the scope of the invention. Accordingly, the system and method, the use, steps, order of steps, etc. may be varied as a matter of application specific design choice without deviating from the scope of the invention. For example, whereas the embodiments of Tag 100 have been illustrated and described having one Integrated Circuit 120, it is to be understood that multiple Integrated Circuits 120 may be provided within a Tag 100, wherein each Integrated Circuit 120 has its own Tag ID. Such a Tag having multiple Integrated Circuits may be similar to a plurality of Tags 100 stacked on top of each other or overlapping, as discussed above. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall there between.

We claim:

1. A tag capable of wireless data communication with a mobile device, said tag comprising:
an inlay having an antenna and an NFC integrated circuit chip capable of performing wireless data communication with an NFC-enabled mobile device; and
a memory element for storing tag data regarding said tag, and content data corresponding to content stored on a server accessible wirelessly by said mobile device upon scanning said tag.

2. The tag of claim 1, further comprising a write-enabled pin for receiving data to permit new content to be saved from said mobile device onto said server after said mobile device scans said tag; whereupon after said write-enabled pin is physically broken, said server does not receive data from said mobile device after said mobile device scans said tag.

3. The tag of claim 1, wherein said memory element comprises:
a first section in which said tag data is stored;
a second section in which said content data is stored; and
a third section in which a log of said tag's activities is stored.

4. The tag of claim 1, wherein said server comprises a tag folder for storing said content.

5. The tag of claim 1, wherein a user, upon scanning said tag with said mobile device, is presented with one or more content data to select from, and upon selecting one of said content data, one of said content corresponding to said content data is transferred from said server to said mobile device.

6. The tag of claim 1, further comprising a body having an adhesive portion.

7. The tag of claim 1, further comprising a body having an adhesive portion and a removable cover for said adhesive portion, said removable cover comprising a write-antenna by which said tag receives data from said mobile device.

8. The tag of claim 1, wherein said tag comprises:
a write mode wherein said server receives new content from said mobile device; and
a read-only mode, wherein said server transfers said content from said server but does not receive said new content from said mobile device.

9. The tag of claim 1, wherein said tag is constructed to be rendered read-only by software.

10. The tag of claim 1, wherein said content is one or more of: video files, audio files, image files or pointer to a content on a second server.

11. The tag of claim 1, wherein said tag is constructed and arranged to communicate with an application on said mobile device.

12. The tag of claim 1, wherein said tag is constructed and arranged to transmit a signal to said mobile device to grant said mobile device access to a chatroom via which one or more users who have scanned said tag may communicate.

13. The tag of claim 1, wherein said tags is constructed and arranged to transmit a signal to said mobile device to grant said mobile device access to said content for a predetermined period of time.

14. A tag capable of wireless data communication with a mobile device, said tag comprising:
an inlay having an antenna and an NFC integrated circuit chip capable of performing wireless data communication with an NFC-enabled mobile device via an application on said mobile device; and
a memory element for storing one or more tag data regarding said tag, and one or more content data corresponding to one or more content stored on a server accessible wirelessly by said mobile device upon scanning said tag;
wherein upon said tag being scanned by said mobile device, said application displays one or more content indicators, each content indicator corresponding to one of said content on said server, and
upon one of said content indicators being selected, said corresponding content is transferred from said server to said mobile device.

15. The tag of claim 14, further comprising a write-antenna constructed and arranged to receive communication from said mobile device.

16. The tag of claim 14, further comprising a write-antenna constructed and arranged to receive one or more new content data from said mobile device.

17. The tag of claim 14, further comprising an adhesive portion.

18. The tag of claim 14, wherein said content is one or more of: video files, audio files, image files or pointer to a content on a second server.

19. The tag of claim 14, wherein said tag is constructed and arranged to transmit a signal to said mobile device to grant said mobile device access to a chatroom via which one or more users who have scanned said tag may communicate.

20. A system for sharing content, said system comprising:
a server onto which one or more content is stored;
a tag capable of wireless data communication with a mobile device, said tag comprising:
an inlay having an antenna and an NFC integrated circuit chip capable of performing wireless data communication with an NFC-enabled mobile device; and
a memory element for storing tag data regarding said tag, and content data corresponding to said content stored on said server, wherein said content is accessible wirelessly by said mobile device upon scanning said tag.
